(19) United States
(12) Patent Application Publication
(10) Pub. No.: US 2024/0020538 A1
(43) Pub. Date: Jan. 18, 2024

(54) SYSTEMS AND METHODS FOR REAL-TIME SEARCH BASED GENERATIVE ARTIFICIAL INTELLIGENCE

(71) Applicant: SuSea, Inc., Palo Alto, CA (US)

(72) Inventors: Richard Socher, Palo Alto, CA (US); Bryan McCann, Palo Alto, CA (US)

(21) Appl. No.: 18/354,506

(22) Filed: Jul. 18, 2023

Related U.S. Application Data
(60) Provisional application No. 63/390,134, filed on Jul. 18, 2022.
(60) Provisional application No. 63/476,917, filed on Dec. 22, 2022.

(51) Int. Cl. G06N 3/08; G06F 16/242; G06F 16/248

(52) U.S. Cl. CPC G06N 3/08; G06F 16/243; G06F 16/248

(57) ABSTRACT

Embodiments described herein provide systems and methods for a customized generative AI platform that provides users with a tool to generate various formats of responses to user inputs that incorporate results from searches performed by the generative AI platform. The system may use a neural network to utilize input data and contextual information to identify potential search queries, gather relevant data, sort information, generate text-based responses to user inputs, and present response and search results via user-engageable elements.

### CROSS REFERENCES

The instant application is a nonprovisional of and claims priority under 35 U.S.C. 119 to co-pending and commonly-owned U.S. provisional application Nos. 63/390,134, filed Jul. 18, 2022, and 63/476,917, filed Dec. 22, 2022, each of which are hereby expressly incorporated by reference herein in its entirety.

### TECHNICAL FIELD

The embodiments relate generally to search engines and machine learning systems, and more specifically to a real-time based generative artificial intelligence (AI) conversation application.

### BACKGROUND

Generative AI technology has been recently growing in assisting intelligent agent to conduct conversations with human users. For example, large language models (LLMs) such as ChatGPT, GPT-4, Google Bard, and/or the like have provided a conversation AI platform for performing a number of natural language processing (NLP) tasks. However, these LLMs usually require multiple stages of pretraining, training and finetuning using carefully curated training datasets to perform NLP tasks. In other words, these LLMs may often only distill knowledge based on which an NLP output is provided from existing knowledge from the training data they have been exposed to.

### BRIEF DESCRIPTION OF THE DRAWINGS

FIG. 1A is a simplified diagram illustrating data flows between entities implementing the processes described in FIGS. 2-11, according to one embodiment described herein.

FIG. 1B is a simplified diagram illustrating data flows between entities implementing the processes described in FIGS. 2-11, according to another embodiment described herein.

FIG. 2 is a simplified diagram illustrating a computing device 200 implementing the text generation server 110 described in FIGS. 1A and 1B, according to one embodiment described herein.

FIG. 3 is a simplified diagram illustrating the neural network structure implementing the text generation module 230 described in FIG. 2, according to one embodiment described herein.

FIG. 4 is a simplified diagram illustrating an example architecture of the NL preprocessing module 231 and search module 232 shown in FIG. 2, according to embodiments described herein.

FIG. 5 is a simplified block diagram illustrating an example architecture of a generation submodule 233 shown in FIG. 2, according to embodiments described herein.

FIG. 6 is a simplified block diagram of a networked system suitable for implementing the customized generative AI platform framework described in FIGS. 1A and 1B and other embodiments described herein.

FIG. 7 is an example logic flow diagram illustrating a method of customized search based on the framework and architecture shown in FIGS. 1-6, according to some embodiments described herein.

FIG. 8 is an example logic flow diagram illustrating a method of customized search based on the framework and architecture shown in FIGS. 1-6, according to some embodiments described herein

FIG. 9 is an example logic flow diagram illustrating a method of a generative AI system based on the framework shown in FIGS. 1-6, according to some embodiments described herein.

FIGS. 10A-10E provide example UI diagrams illustrating an embodiment implementing a generative AI system incorporated into a search system, according to embodiments described herein.

FIG. 11 provides an example UI diagram illustrating an embodiment implementing a text generation tool based on set user parameters, according to embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The present application generally relates to search engines and machine learning systems, and more specifically to systems and methods of a language model-based search assistance tool.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

Generative AI technology and LLMs has been recently growing in assisting intelligent agent to conduct conversations with human users. However, existing LLMs generally can only provide a generative output based on knowledge they have obtained from prior training data. For example, if a user enters a question that requires real-time knowledge, such as “which stock should I buy today,” these LLM-based chat agent, such as ChatGPT, is unable to provide a satisfactory answer because such chat agent can not obtain the latest time-varying information on the stock market.

On the other hand, search engines allow a user to provide a search query and return search results in response. Users utilize search functionality to learn about topics, stay up to date on the news, perform research, and accomplish other tasks. In this manner, search results may provide significant utility in preparing written content, for example, writing an essay or paper. For instance, a user may look to write a summary highlighting Abraham Lincoln and the Civil War. However, it is time consuming for a user to review the hundreds, thousands, millions, or more search results that are returned from a search query. While traditional search engines provide utility in performing research on specific topics and aggregating a wide array of information, reviewing search results, identifying pertinent information, and composing materials incorporating information from a search can be a time-consuming endeavor. In view of the need for improved generative AI systems that reflect on time-varying information such as real-time news events, embodiments described herein provide systems and methods for a real-time search based generative AI platform. Specifically, in response to a user input to perform an NLP task, the generative AI platform may trigger a real-time search based on the user input, and then aggregate search results to generate an output. The search may be performed as an Internet web search based on web indexing, and/or dedicated search from a few selected data sources. In one embodiment, the generative AI platform may parse contents following a web link in the search results, and use the parsed contents as part of the input to generate a text answer in response to a user input.

In another embodiment, the generative AI platform may comprise a vision-language model such that the vision-language model may obtain and generate a summary of vision content (such as image or video content) from a searched web link, and use such summary as an input to generate a text answer in response to a user input.

For example, specialized output may be generated based on user input queries to summarize results, answer questions, draft emails, essays, newsletters, posts, etc., and efficiently distill information for users. In one embodiment, the generative AI system adopts a machine learning module to receive plain text input, generate conversational output, and provide citations to search results that support the generated content. In this way, instead of having to visit and review many webpages, a user may receive a concise answer to a query with citations supporting and confirming the output, thus reducing time to find answers while providing certainty in correctness. In some embodiments, the generative AI system may provide suggested follow up responses for the user to generate additional conversational responses, as well as suggested search results, apps, or other information that may further assist the user.

For another example, a text-generation based search tool that provides text based on user-provided parameters. Specifically, a user may provide parameters such as a use case for the generated text, a desired tone, a target audience, and a subject. The system adopts a machine learning module to receive the user parameters, perform a search based on the subject, and incorporate results and the user parameters to generate text output. The generative AI system may further provide citations or relevant search results to allow the user to verify information, perform further research. In some embodiments, the generative AI system may further provide suggestions on additional topics, alternative parameters that may be of use to the user, or other information that may assist the user in using the generated text or generating more text.

In this way, the generative AI system may generate a text output based on real-time search results that reflect most-up-to-date information according to a user query. Generative AI technology is thus improved.

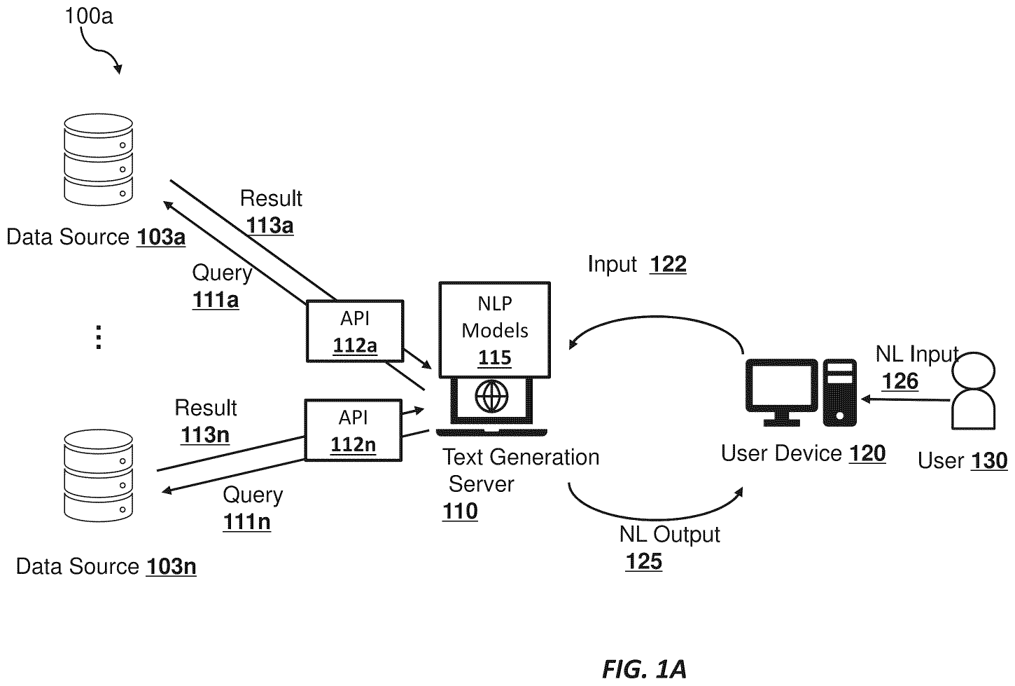

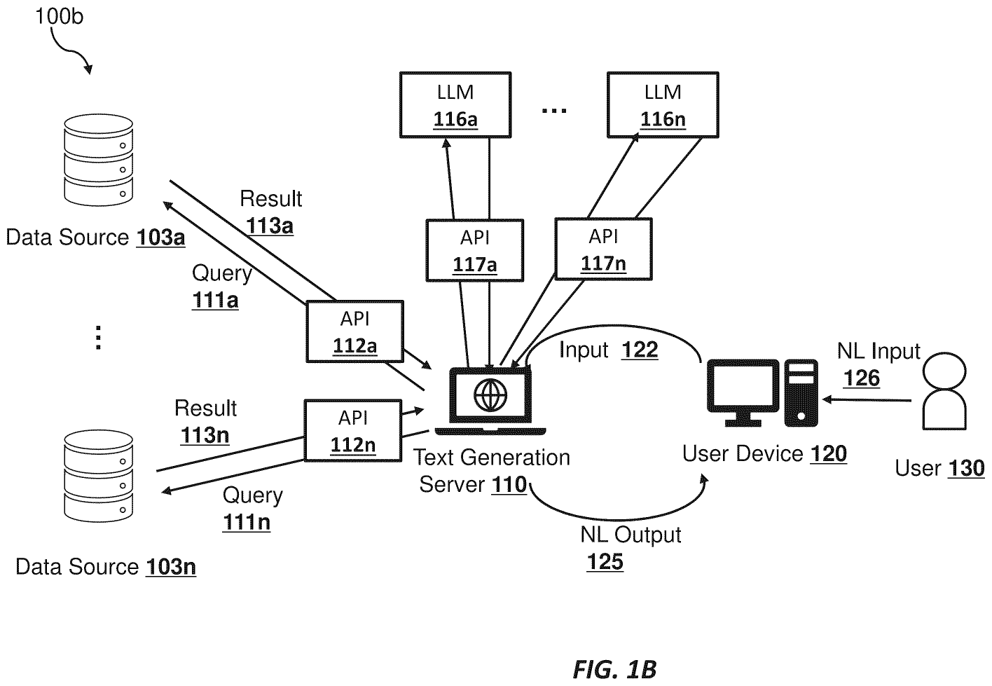

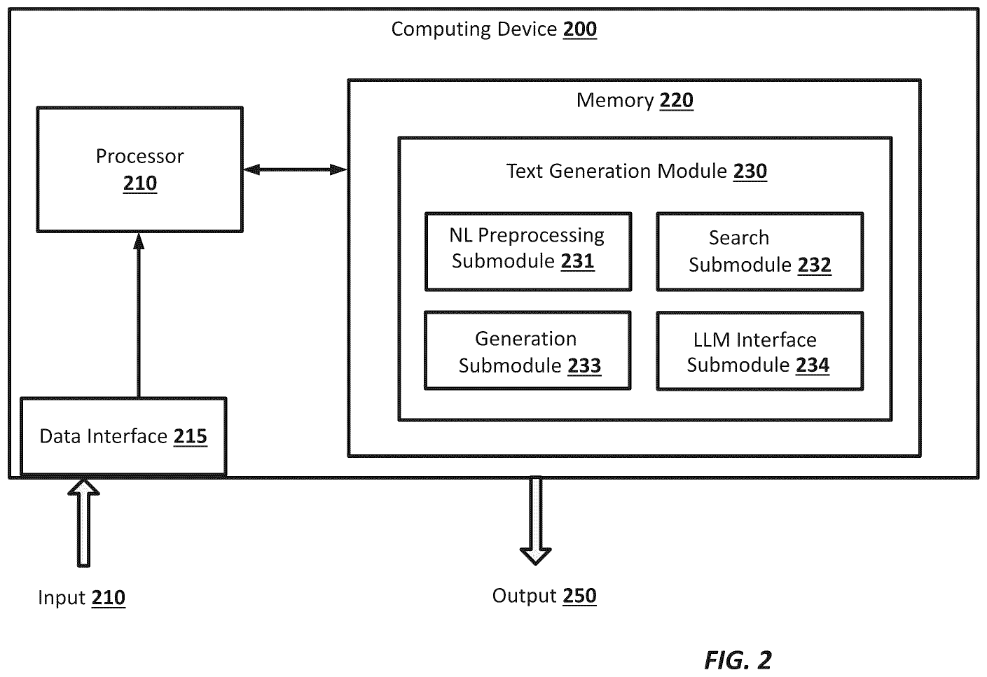

FIG. 1A is a simplified diagram illustrating data flows between entities implementing the processes described in FIGS. 2-11, according to one embodiment described herein. A user 130 interacts with user device 120, e.g., through providing natural language (NL) input 126, which in turn interacts with a text generation server 110 that hosts one or more natural language processing (NLP) models 115 through input 122. The input 122 may include a user NL input 126 such as a user question, user parameters, user context, or other context. The user parameters may include any user configured parameters for the natural language task, such as an intended audience, a type of the task (composing an email, a summary, a research article, and/or the like), a tone of the output, and/or the like. The user context may include any user preferences such as a user preferred search data source, user activities on social media, and/or the like.

In one embodiment, text generation server 110 interacts with various data sources 103a-n (collectively referred to as 103). For example, the data sources 103a-n may be any number of available databases, webpages, servers, blogs, content providers, cloud servers, and/or the like.

In one embodiment, upon receiving input 122, the text generation server 110 may determine whether a real-time search is needed, and/or which data source(s) may be searched. In one embodiment, the text generation server 110 may adopt at least NLP model 115 to generate a search query. For example, in one implementation, the text generation server 110 may extract key terms from the text input 126 as search queries. For another example, in one implementation, the text generation server 110 may generate text embeddings and conduct a vector search based on the text embeddings. For another example, the text generation server 110 may conduct a combined search based on both the text queries, and vector embeddings.

In one embodiment, the text generation server 110 may adopt at least NLP model 115 to generate an NLP output.

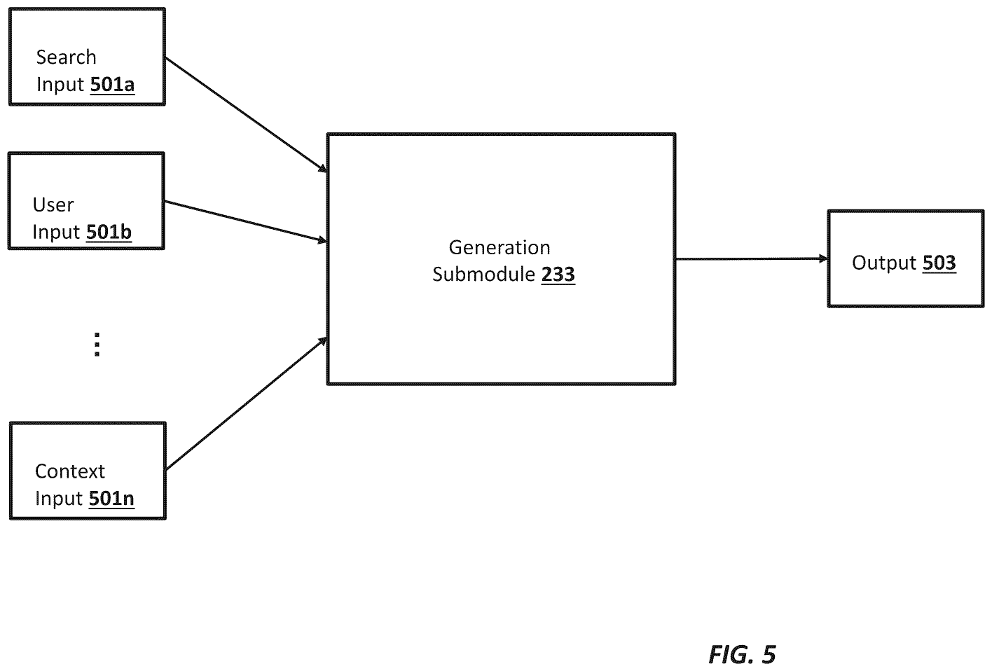

In one embodiment, the text generation server 110 may engage neural network based AI models 115 to predict relevant data sources for the search based on an user input. Additional details of determining specific data sources based on the search query may be found in relation to FIG. 5, and in co-pending and commonly-owned U.S. nonprovisional application Ser. No. 17/981,102, filed Nov. 4, 2022.

For another example, when the text generation server 110 receives input 122 from a user device 120 the text generation server 110 may determine data sources that have been pre-defined as related to key words, phrases, topics, parameters, or other elements of input 122 related to search. The determined data sources may be further subject to prior user interactions, e.g., a user disapproving a search result from certain data sources, a user pre-configured preferred data sources, and/or the like.

In one embodiment, the text generation server 110, upon receiving input 122, may determine what to generate as a search query, how many search queries to generate, and other parameters related to performing searches. For example, as further described in relation to FIGS. 2-6, the text generation server 110 may host one or more neural network based prediction modules. The prediction module may generate a query based on key words or phrases in input 122, user parameters, and/or other context information when the prediction module determines a search shall be performed on a specific element or elements from input 122.

In one embodiment, the text generation server 110 may then convert the search query into customized search queries 111a-n that comply with a format requirement specific to data source 103a-n, respectively. The customized search queries 111a-n are sent to respective data sources 103a-n through respective APIs 112a-n. In response, the data sources 103a-n may return query results 113a-n in the form of links to webpages and/or cloud files to the text generation server 110.

Instead of solely presenting links to search results (e.g., webpages) to a user device 120, the text generation server 110 may utilize one or more NLP models 115 to extract information from the search results, generate text based on the search results and any parameters specified in input 122, generate a natural language response, and return as a NL output 125 for display at the user device 120.

For example, at least one NLP model 115 may be used to parse the web content following the links provided in search results 113a-n. In one embodiment, at least one NLP model 115 may generate a summary of the web content from at least one search result 113a, and use such generated summary to generate the final NL output 125.

In one embodiment, at least NLP model 115 may be used to generate an output NL output 125 based on the parsed content from search results 113a-n, and/or additional user configured parameters. For example, the user configured parameters may specify a type of the NLP task (e.g., composing an email, composing a legal memorandum, conducting a conversation, and/or the like), the intended audience for the NL output 125, a tone of the NL output, and/or the like.

It is to be noted that the text generation server 110, NL output 125 and/or the NLP models 115 are for illustrative only. The framework 100 may be applied to any type of generation and/or generative model, and/or generating any type of output such as but not limited to a code segment, an image, and/or the like.

For example, input 122 may take various formats such as a text input, an audio input, an image input, a video input, and/or the like. For instance, input 122 may comprise two images and a text question “which photo is taken at the BTS 2023 tour at Barclay Center, New Yor City?” An image encoder, together with NLP models 115, may then be used to encode the image input to facilitate a search based on the image encodings. In another implementation, a captioning model may be employed to generate a caption of the input images such that the server 110 may conduct a search using the text captions of the input images.

For another example, input 122 may comprise an audio clip (e.g., of a music song). The server 110 may generate audio signatures from the audio clip and conduct a search, e.g., at a data source storing a library of music songs. Upon receive a name and/or title of music works relating to the audio clip from the data source, the server 110 may further generate a search based on the obtained name and/or title of the music work to obtain search results relating to the music work. For instance, a music clip that a user recorded at Times Square, New York may be uploaded to the generation server, which may in turn identify the music clip belongs to Broadway musical Phantom of the Opera, and may generate an output (with both text and/or images relating to the musical) containing a short description of the musical, and/or available schedule and tickets for the musical and a link to purchase.

For example, a vision-language model may be employed together or in place of the NLP model 115 at the text generation server 110 to parse image and/or video content from at least one search result 113b, and generate a summary of the image and/or video content. Such summarized multimedia content may be used to generate the NL output 125. For another example, the vison-language model and/or other multi-modal model employed at text generation server 110 may generate a text captioning of an image retrieved from a webpage following a search result link. The text captioning may be fed together with other text inputs from the search results to the NLP models for generating the NL output 125.

For another example, when the user input 122 relates to a query on coding, such as “what is the difference to compile a list in Python and C #?”, the text generation server 110 may conduct a code search, and may generate an output based on the search results 113a-n. The output may comprise a code segment in Python and a code segment in C #, and a text portion explaining difference between the two code segments. Additional details on conducting a code search to obtain a code segment may be found in co-pending and commonly-owned U.S. nonprovisional application Ser. No. 18/330,225.

For another example, the generation server 110 may further employ the NLP models 115 as a code generation model to generate code segments based on the search results 113a-n.

For another example, the generation server 110 may further insert one or more images retrieved from a webpage following a search result link into the NL output 125 as illustration. For instance, when the input 122 contains a request “please write a paragraph about the history of direct current vs. alternate current,” in addition to generate a text summary based on various search results, the NLP models 115 may further insert web images of Thomas Edison and Nikola Tesla into the output 125 for illustration.

For another example, the generation server 110 may further employ an image generation model which may generate image content based on text content and/or image content obtained from search results 113a-n to form the output 125. For instance, when the input 122 contains a question “why is Hilary Step at Mount Everest so famous?”, an image generation and/or editing model may edit a photo of Hilary Step obtained from search results 113a-n by adding measurement labels showing the height, slope, temperature, wind speed and/or the like overlaying the photo, and use the edited photo in the generated output 125 for illustration.

In one embodiment, the NL output 125 may comprise references to the data sources 103a-n at relevant portions that are based on the corresponding search results 113a-n, respectively. In this way, the NL output 125 automatically comprises reference authority.

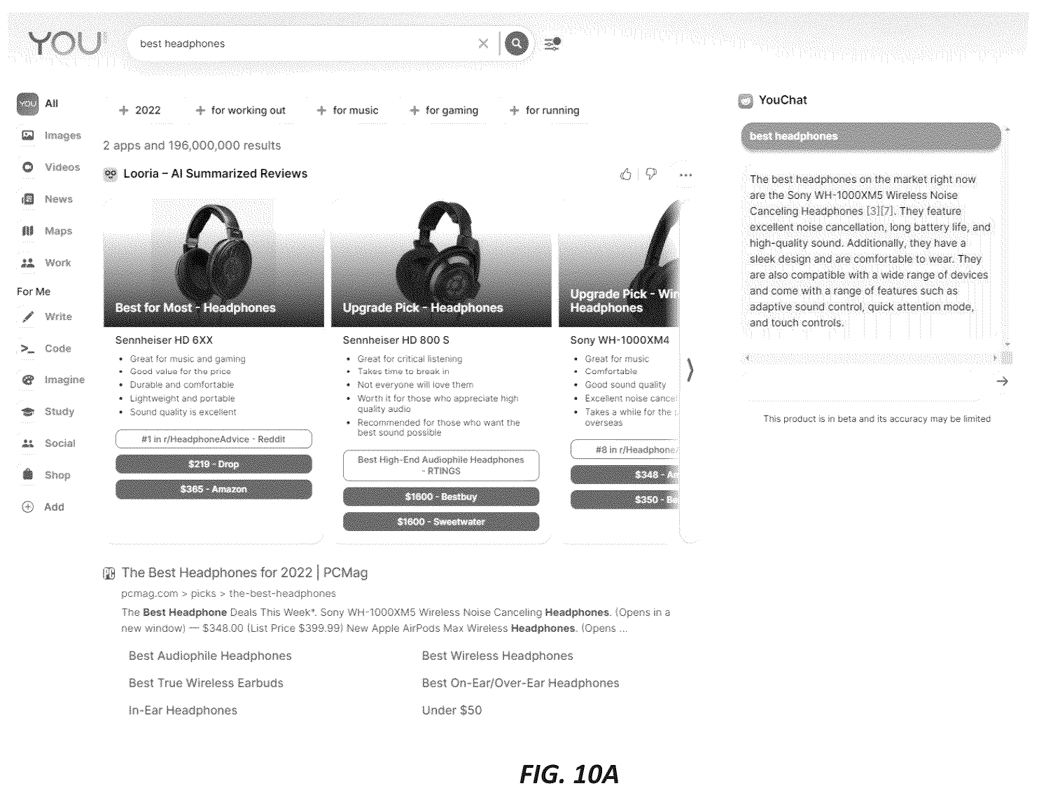

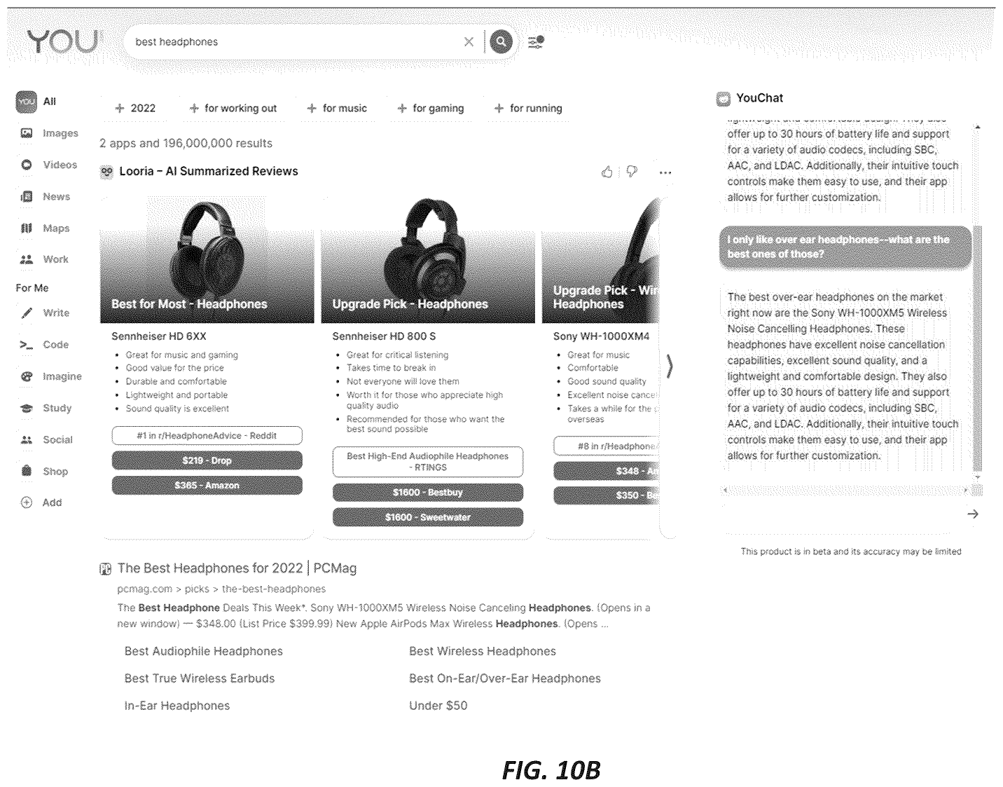

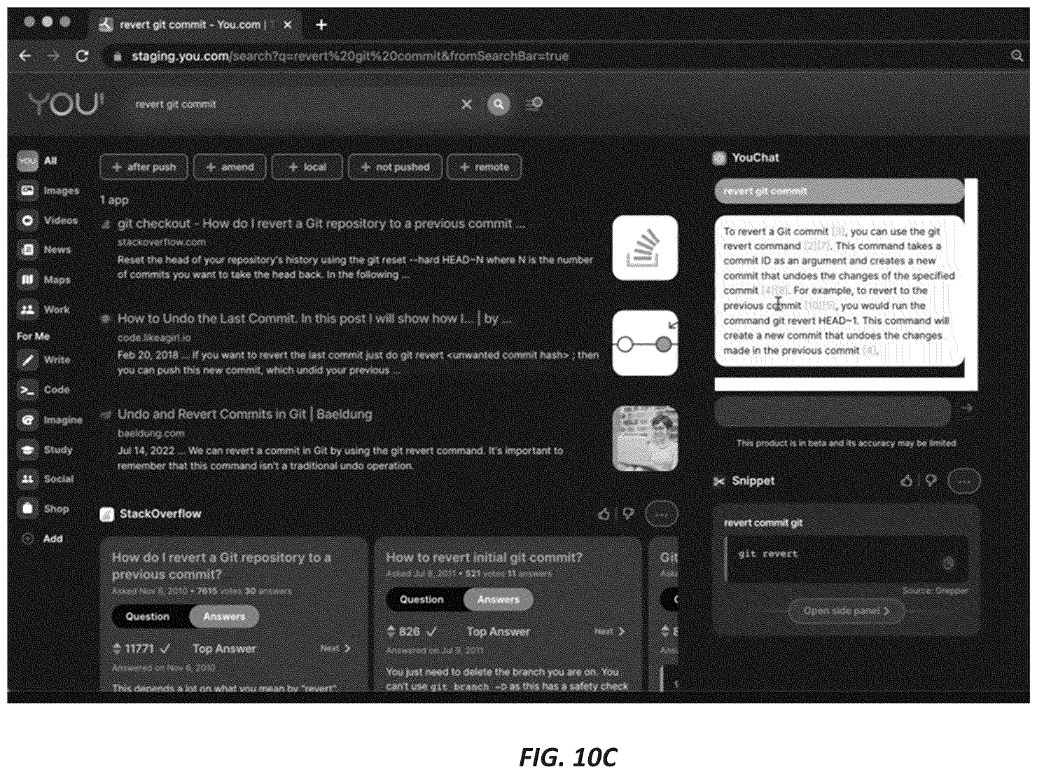

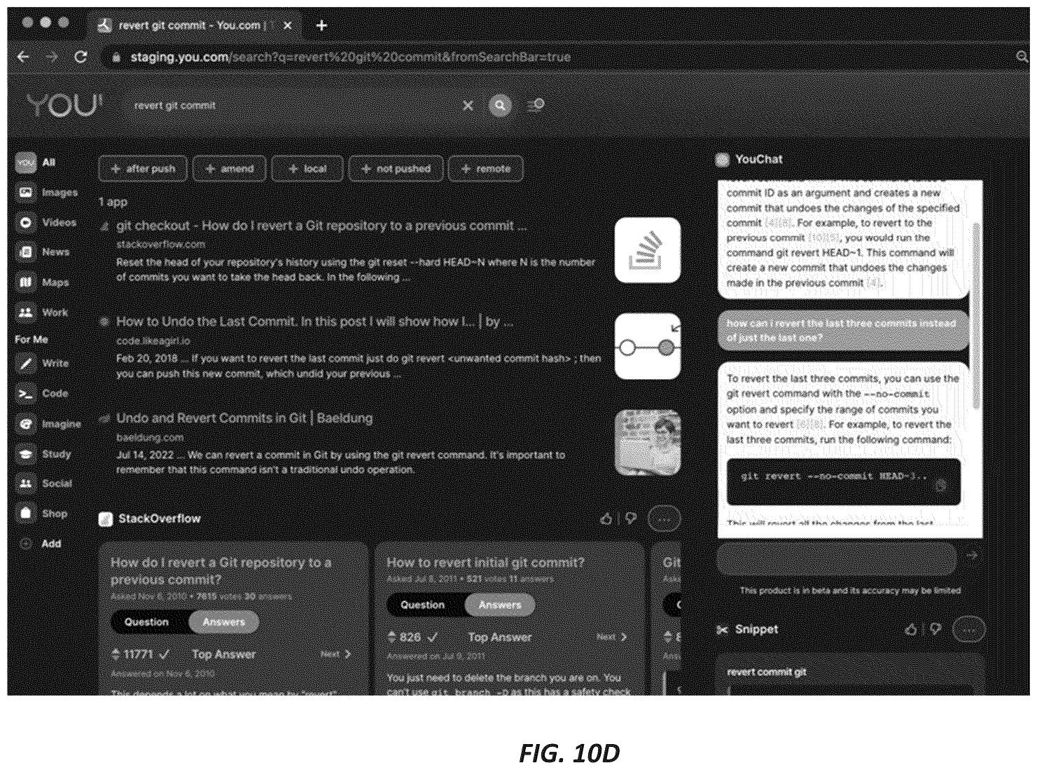

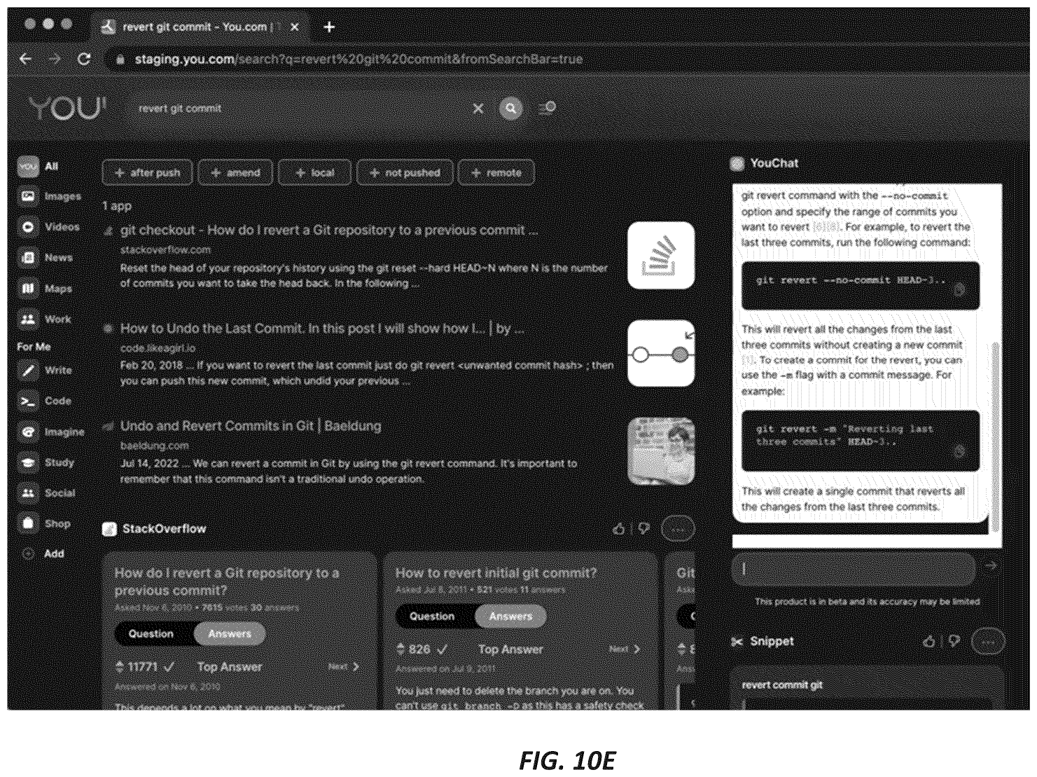

In one embodiment, a client component at the user device 120 may display the NL output 125 via a user interface. For example, the NL output 125 may be displayed at a side panel within a search browser, e.g., as shown in FIGS. 10A-10E. In another example, the NL output 125 may be displayed at a mobile UI on a mobile user device 120 in the form of a conversation with a cloud agent.

FIG. 1B is a simplified diagram illustrating data flows between entities implementing the processes described in FIGS. 2-11, according to another embodiment described herein. As shown in FIG. 1B, the text generation server 110 may, instead of and/or in addition to hosting its own NLP models 115 as shown in FIG. 1A, communicate with a number of external LLMs 116a-n housed at external servers.

In one embodiment, the LLMs 116a-n may be housed at external servers accessible by the text generation server 110 via a network. In another embodiment, the LLMs 116a-n (or a copy thereof) may be housed at the text generation server 110. The text generation server 110 may communicate with the LLMs 116a-n via their respective APIs 117a-n. In one embodiment, text generation server 110 processes input 122 and interacts with data sources 103a-n in a similar way to obtain search results 113a-n as described with respect to FIG. 1A. When text generation sever receives results 113a-n from data sources 103a-n, text generation sever 110 may generate an NLP input comprising the search results 113a-n, and send the NLP input to one or more LLM 116a-n via the respective APIs 117a-n. For example, in one implementation, an NLP input to one or more LLMs 116a-n may be a concatenation of the search results 113a-n including their respective links, and/or a prompt indicating a type of the NLP task.

In one embodiment, the text generation server 110 may select a LLM from candidate LLMs 116a-n for forwarding the NLP request depending on a type of the NLP task. For example, a LLM 116a may be used for composing an article, while another LLM 116b may be selected for generating a system response in a conversation. The text generation server 110 may then generate NL output 125 based on the outputs from the LLMs and return to the user device 120 for display. In one embodiment, the text generation server 110 may select a LLM rom candidate LLMs 116a-n depending on the type of data sources from which the search results are obtained. For example, when the input 122 inquires “what's up with the latest tour of BTS?”, a search module (e.g., 232 in FIG. 2) at the generation server 110 may determine to prioritize searches on social media sources (e.g., because of the query terms “tour,” “BTS”). The generation server 110 may then determine that due to the nature of data sources, the search results 113a-n may contain large amounts of image and/or video content. The generation server 110 may then select LLMs that are capable of handling vision data for forwarding the request to generate an output.

FIG. 2 is a simplified diagram illustrating a computing device 200 implementing the text generation server 110 described in FIGS. 1A and 1B, according to one embodiment described herein. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200.

Computing device 200 may be implemented as a stand-alone subsystem, as a board added to a computing device, and/or as a virtual machine. In various embodiments, the communication device may comprise a personal computing device (e.g., smart phone, a computing tablet, a personal computer, laptop, a wearable computing device such as glasses or a watch, Bluetooth device, etc.) capable of communicating with the network. The service provider may utilize a network computing device (e.g., a network server) capable of communicating with the network. It should be appreciated that each of the devices utilized by users and service providers may be implemented as computer system 200 in a manner as follows.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

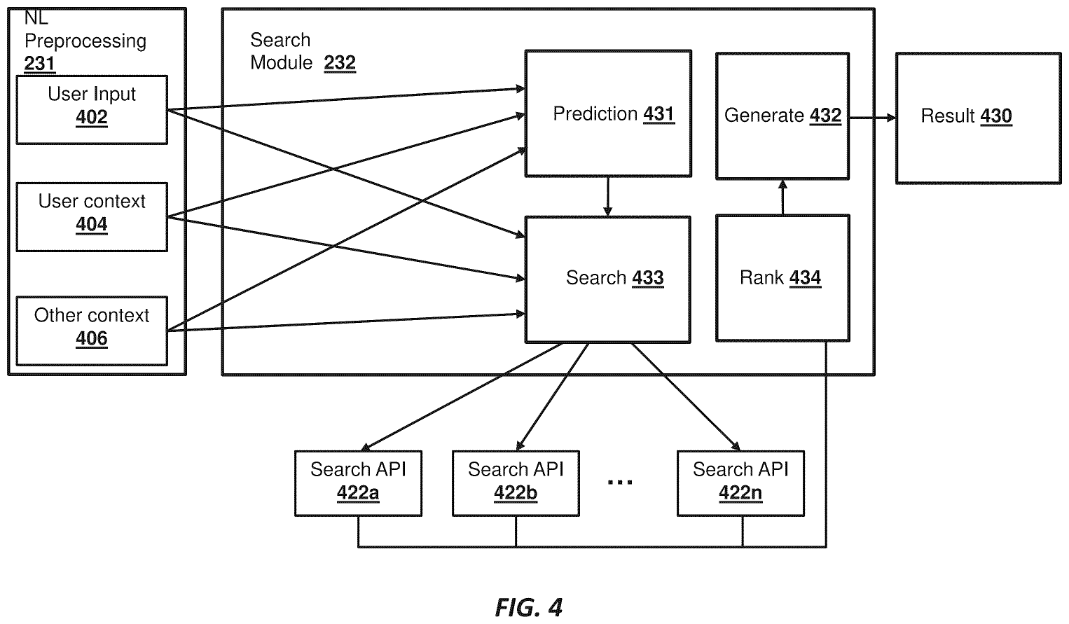

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for search platform module 230 that may be used to implement and/or emulate the systems and models, and/or to implement any of the methods described further herein. A search platform module 230 may receive input 240 such as an input search query (e.g., a word, sentence, or other input provided by a user), user parameters, and/or the like, via the data interface 215 and generate an output 250 which may be a conversational text-based response presented in an element along with supporting links to different data sources, suggestions for future user inputs, suggestions for further user exploration, and/or the like. Examples of input data may include any input 122 in FIG. 1 and described in more detail with respect to FIG. 4, such as a user query 402, user context 404, and/or other context 406 such as parameters, current events, and/or the like.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as a user entered search query or parameters, from a user via the user interface.

In some embodiments, the text generation module 230 is configured to generate text-based conversational responses to a user device (e.g., 120 in FIGS. 1A and 1B). The text generation module 230 may further include an NL preprocessing submodule 231, a search submodule 232, a generation submodule 233, and (optionally) an LLM interface submodule 234. The NL preprocessing submodule 231 may perform processing steps to assist in performing searches, generating an NL output, or other steps taken by text generation module 230. For example, NL preprocessing submodule 231 may tokenize and generate a search query based on received input, user parameters, or other information (e.g., 122 in FIGS. 1A and 1B). NL preprocessing submodule 231 may also determine how many searches to perform and what words, topics, or phrases to search. The search submodule 232 may determine one or more data sources for the search, e.g., based on user configuration of preferences, user past behavior indicating a preference, the search query, a source type, and/or the like. The search submodule 232 may further generate customized queries according to each data sources, and transmits the customized queries to the corresponding APIs (e.g., 112a-n in FIGS. 1A and 1B) and receives search results from the APIs. Additional details of operations of the search submodule 232 may be found in FIG. 5 and co-pending and commonly-owned U.S. nonprovisional application Ser. No. 17/981,102, filed Nov. 4, 2022. The generation submodule 233 may generate text-based output fora user based off of received and processed search results, user input, and information determined by the NL preprocessing submodule 231. In some embodiments, the generation submodule will finalize and generate output based on data received and processed by NL preprocessing submodule 231, search submodule 232. In other embodiments, generation submodule 233 will generate results as output 250 based on data received from optional LLM interface submodule 234. The LLM interface submodule 234 may interface with LLMs external to text generation module 230, prepare inputs for APIs associated with external LLMs, prepare prompts based on search results received by search submodule 232, prepare prompts based on inputs processed by NL preprocessing submodule 231, and/or the like. LLM interface submodule 234 may also process results received from external LLMs and provide them to generation submodule 233. Additional functionality of the search submodules 232 may be further described in relation to FIG. 4.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

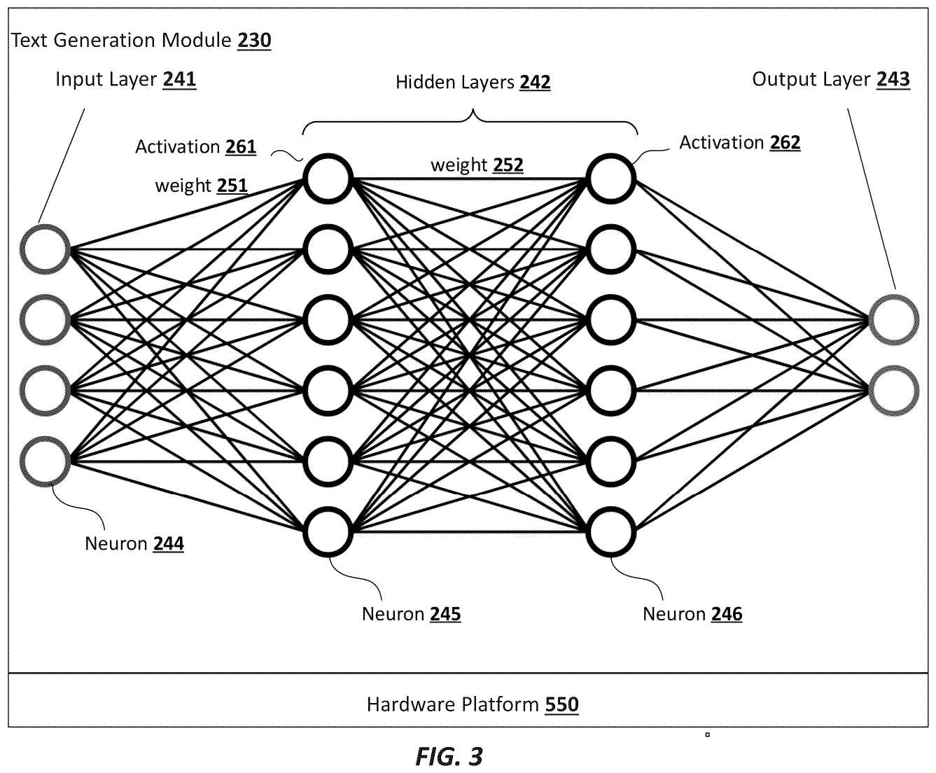

FIG. 3 is a simplified diagram illustrating the neural network structure implementing the text generation module 230 described in FIG. 2, according to one embodiment described herein. In one embodiment, the text generation module 230 and/or one or more of its submodules 231-234 may be implemented via an artificial neural network structure shown in FIG. 3. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 210 in FIG. 2), such as a user input query (e.g., 122 in FIGS. 1A and 1B), user entered preferences, and/or the like. The number of nodes (neurons) in the input layer 241 may be determined by the dimensionality of the input data (e.g., the length of a vector of give an example of the input). Each node in the input layer represents a feature or attribute of the input.

The hidden layers 242 are intermediate layers between the input and output layers of a neural network. It is noted that two hidden layers 242 are shown in FIG. 5 for illustrative purpose only, and any number of hidden layers may be utilized in a neural network structure. Hidden layers 242 may extract and transform the input data through a series of weighted computations and activation functions.

For example, as discussed in FIG. 2, the text generation module 230 receives an input 210 including a user input, parameters, and/or other information, and transforms the input into an output 250 of a text-based response tailored to the input. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the text generation module 230 and/or one or more of its submodules 231-234 may comprise the transformative neural network structure of layers of neurons, and weights and activation functions describing the non-linear transformation at each neuron. Such a neural network structure is often implemented on one or more hardware processors 210, such as a graphics processing unit (GPU).

In one embodiment, the text generation module 230 and its submodules 231-234 may be implemented by hardware, software and/or a combination thereof. For example, the text generation module 230 and its submodules 231-234 may comprise a specific neural network structure implemented and run on various hardware platforms 550, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 550 used to implement the neural network structure is specifically configured depends on factors such as the complexity of the neural network, the scale of the tasks (e.g., training time, input data scale, size of training dataset, etc.), and the desired performance.

In one embodiment, the neural network based text generation module 230 and one or more of its submodules 231-234 may be trained by iteratively updating the underlying parameters (e.g., weights 251, 252, etc., bias parameters and/or coefficients in the activation functions 261, 262 associated with neurons) of the neural network based on a loss objective. For example, during forward propagation, the training data such as past coding activities are fed into the neural network. The data flows through the network's layers 241, 242, with each layer performing computations based on its weights, biases, and activation functions until the output layer 243 produces the network's output 250, such as a generated text.

The output generated by the output layer 243 is compared to the expected output (e.g., a “ground-truth” such as the corresponding give an example of ground truth label), e.g., the actual text from the training data. For example, the loss function may be cross entropy, mean square error (MSE), and/or the like. Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

Parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as user queries and specific parameters for responses.

Therefore, the training process transforms the neural network into an “updated” trained neural network with updated parameters such as weights, activation functions, and biases. The trained neural network thus improves neural network technology in cloud-based generative AI systems.

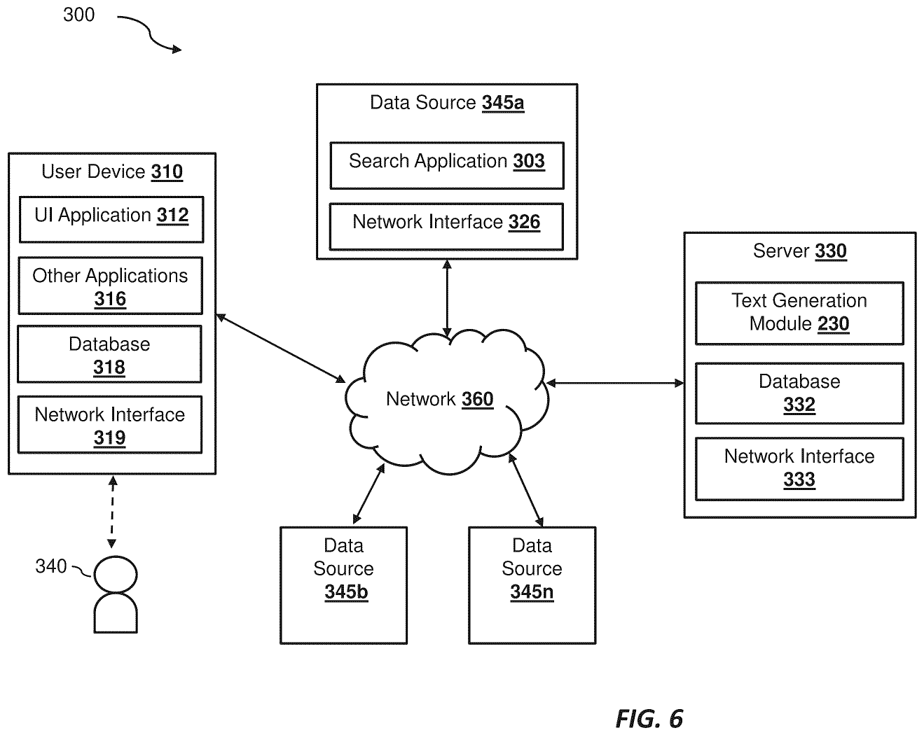

FIG. 4 is a simplified diagram illustrating an example architecture of the NL preprocessing module 231 and search module 232 shown in FIG. 2, according to embodiments described herein. The NL preprocessing module 231 and/or the search module 232 may comprise a software and a hardware platform that is implemented at the text generation server 110 in FIGS. 1A and 1B, and/or the server 330 in FIG. 6. For example, the text generation module 230 may be implemented based on a neural network structure shown in FIG. 3.

In one embodiment, NL preprocessing module 231 receives input data. This input data may include one or more of a natural language user input 402 (which is similar to NL input 126 in FIGS. 1A and 1B), user context 404, and other context 406. Natural language user input 402 may include a word, multiple words, a sentence, or any other type of search query provided by a user performing a search using platform 230. In some embodiments, natural language user input 402 may be in the form of a conversational statement or question. For example, the natural language user input 402 may be a search term such as “what is a quasi recurrent neural network,” “who is Richard Socher,” etc. User context 404 may include inputs representative of the user, including a user ID, user preferences, user click logs, or other information collected or provided by the user, user selected preferred data sources, user past activities “like” or “dislike” a search result or a search source, and/or the like. Other context 406 may include inputs representative of other useful input information, including information about world events, searches that have been conducted around the same time, searches that have been conducted around the same area, searches that increased in volume over a period of time, or other potential contextual information that may assist platform 410 in providing appropriate search responses to the user. Other context 406 may further contain input selections that the user includes with typed input, such as a desire to have a response that is “professional,” “causal,” “comedic,” etc., to indicate a desired output such as “paragraph,” “sentence,” “essay,” etc., and/or the like.

In one embodiment, other context 406 may comprise user configured generation parameters such as a type of output (e.g., a paragraph, an email, a legal memorandum, an article, a conversation response, and/or the like), an intended audience (e.g., elementary school students, professionals, friends, social media, etc.), a tone (e.g., informative, persuasive, analytical, and/or the like), a length, and/or the like.

In one embodiment, the NL preprocessing module 231 may concatenate input information such as natural language user input 402, user context 404, and other context 406 into an input sequence of tokens, and generate one or more predicted text queries. The prediction may be performed when a new natural language user input 402 is received. In some embodiments, the NL preprocessing module 231 may further take into account prior natural language user inputs 402, user context 404, and other context 406 received from the same user or a different user to generate one or more predicted text queries. Further, in some embodiments, the NL preprocessing module 231 may instead reuse previous predicted text queries based on similarities between current input information and prior input information.

The NL preprocessing module 231 may be trained on a dataset of previous natural language user inputs 402, previous user context 404, and/or previous other context 406, and a corresponding ground-truth query.

The search module 232 may receive one or more search queries from the NL preprocessing module 231, and subsequently determine a list of data sources for the search. In one implementation, the search module 232 may retrieve a pre-defined list of data sources that have been pre-categorized based on subjects determined by the NL preprocessing module 231. In another implementation, the search module 232 may use a prediction module 431 to predict prioritized data sources for the search based on a concatenation of the natural language user input 402, user context 404 and/or other context information 406, in a similar manner as described in co-pending and commonly-owned U.S. nonprovisional application Ser. No. 17/981,102, filed Nov. 4, 2022.

The search module 232 and its corresponding search module 433 may then send one or more search queries, customized for each identified data source, to the respective search APIs 422a-n and receive a list of search results from the respective search APIs 422a-n.

In some embodiments, a rank module 434 may optionally rank a list of search apps 422a-n to conduct the search. Each search application 422a-n corresponds to particular data sources 103a-n in FIGS. 1A and 1B. For example, when receiving an input query related to coding, rank module 434 may select data sources such that search app 422a corresponds to a search application that is configured to search within the database of “StackOverflow”; search app 522b corresponds to a search application that is configured to search within the database of “Tutorial Point,” and/or the like. The rank module 434 uses the input sequence processed by NL preprocessing 231 including natural language user input 404, user context 404, and other context 406 to score the plurality of search apps 422a-n, by running the input sequence through a neural network model once for each search app 422a-n. In this way, the rank module 434 may rank the search results from the list of data sources via search APIs 422a-n.

In some embodiments, if the user has indicated previous preferences for search results from specific sources, as reflected in user context 404, the rank module 434 may rank a search result from those specific sources as higher than from others. Additionally, other context 406 may indicate that other users value specific sources related to identified terms in user query 402; thus, the rank module 434 may incorporate this other context when ranking search results. In some embodiments, rank module 434 may prioritize sources such that it reuses sources in subsequent follow up responses related to earlier user queries 402 from an earlier related conversation with the same user.

Search results from the search APIs 422a-n are often in the forms of links to webpages or cloud files in the respective data sources. A ranked list of search results may be passed from the rank module 434 to the generate module 432.

The generate module 432 may follow the links of search results and extract information from the contents of the webpages or cloud files. The information may then be processed by the generate module 432 and incorporated into a generated text response that is provided to the user as result 430. In one implementation, the generate module 432 may further incorporate links to the webpages or cloud files where information is utilized in the result 430 as citations to support or provide further information to the user.

For example, result 430 is transmitted to the user device for displaying via a graphical user interface or some other type of user output device. While result 430 is primarily a text-based response, relevant search apps may further be incorporated, such as to provide a visual depiction of relevant data in addition to the text response (e.g., to show weather information, stock charts, and/or the like). Result 430 may further include suggested follow up inputs provided by generate module 432, suggested URLs as ranked by rank module 434 and provided by generate module 432, or any other information that is of interest to a user. In other embodiments, result 430 is transmitted to generation submodule 233 for processing and preparation for output to a user, as described further with respect to FIG. 5.

FIG. 5 is a simplified block diagram illustrating an example architecture of a generation submodule 233 shown in FIG. 2, according to embodiments described herein. The generation submodule 233 may comprise a software and a hardware platform that is implemented at the text generation server 110 in FIGS. 1A and 1B, and/or the server 330 in FIG. 6. For example, the generation module 233 may be implemented based on a neural network structure shown in FIG. 3.

In one embodiment, generation submodule 233 (which is similar to 233 in FIG. 2) receives one or more inputs 501a-n, such as a search input 501a (e.g., search results 113a-n in FIGS. 1A-1B) from the data sources, a user input 501b (e.g., original user asked question and/or user entered parameters, etc.) from NL preprocessing submodule 231, context input 501n (e.g., prior conversation context, and/or the like), and/or the like. These inputs may further include search results, links to search results, web content, photos, videos, PDF documents, natural language user input, user context, other context, and/or other data or associated information.

Generation submodule 233 may processes the various data inputs and generate an output 503. For example, the output 503 may be similar to NL output 125 in FIGS. 1A-1B.

In one implementation, generation submodule 233 may further use instructional prompts containing user configured parameters, such as a type of output (e.g., an email, a legal memorandum, a passage, a news article, a conversation, and/or the like), an intended audience (e.g., professional, social media, friends, educational, etc.), a tone (e.g., informative, persuasive, alerting, and/or the like) to guide the content generation. In one implementation, the generation submodule 233, which may comprise one or more NLP and/or multi-modal models, may be trained on a corpus of text documents annotated with the tone and/or intended audience. In one implementation, during training, the prompts that guide the generation submodule 233 to generate relevant text according to the user configured parameters may be updated correspondingly.

For example, generation submodule 233 may prepare a summary of search results, generative text, images, sounds, or other content to be delivered to a user. In some embodiments, generation submodule 233 may insert links to search results within generated context to serve as citations to the generated content.

In some embodiments, generation submodule 233 will operate in conjunction with optional LLM submodule 234 to request and process data from external LLMs based on search results or generated text. In other embodiments, the functionality of optional LLM submodule 234 may be integrated into generation submodule 233.

FIG. 6 is a simplified block diagram of a networked system suitable for implementing the customized generative AI platform framework described in FIGS. 1A and 1B and other embodiments described herein. In one embodiment, block diagram 300 shows a system including the user device 310 which may be operated by user 340, data vendor servers 345a and 345b-345n, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345a and 345b-345n, and the server platform 330 (e.g., similar to search server 110 in FIG. 1) may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data sources 345a and 345b-345n, and the platform 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data source 345 and/or the platform 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive an NL response (e.g., 125 in FIGS. 1A and 1B) from the server 330 in the form of a text-based output with corresponding information and display the message via the UI application 312 (e.g., see FIGS. 10A-10E). In other embodiments, user device 310 may include additional or different modules having specialized hardware and/or software as required.

In various embodiments, user device 310 includes other applications 316 as may be desired in particular embodiments to provide features to user device 310. For example, other applications 316 may include security applications for implementing client-side security features, programmatic client applications for interfacing with appropriate APIs over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. As described in further detail below with respect to FIG. sever 330 may provide an email, text message, or other use-case specific text response for a user 340 based on a query that can be directly incorporated into other applications 316 and sent or processed without further input by the user 340. Other applications 316 may include device interfaces and other display modules that may receive input and/or output information. For example, other applications 316 may contain software programs for asset management, executable by a processor, including a graphical user interface (GUI) configured to provide an interface to the user 340 to view and interact with user-engageable elements displaying text or other elements based on search results.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 319 adapted to communicate with data sources 345a and 345b-345n and/or the server 330. In various embodiments, network interface component 319 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data sources 345a and 345b-345n may correspond to a server that hosts one or more of the search applications 303a-n (or collectively referred to as 303) to provide search results including webpages, posts, or other online content hosted by data sources 345a and 354b-345n to the server 330. The search application 303 may be implemented by one or more relational database, distributed databases, cloud databases, and/or the like. Search application 303 may be configured by platform 330, by data source 345, or by some other party.

In one embodiment, one or more data sources 345a-n may be similar to data sources 103a-n. In one embodiment, one or more additional external servers hosting LLMs (e.g., 116a-n in FIG. 1B) may communicate with the server 330 via the network 360.

In one embodiment, the platform 330 may allow various data sources 345a and 345b-345n to partner with the platform 330 as a new data source. The generative AI system provides an Application programming interface (API) for each data sources 345a and 354b-345n to plug into the service the generative AI system. For example, the California Bar Association may register with the generative AI system as a data source. In this way, the data source “California Bar Association” may appear amongst the available data source list on the generative AI system. A user may select or deselect California Bar Association as a preferred data source for their search. In similar manners, additional data sources 345 may partner with the platform 330 to provide additional data sources for the search such that the user can understand where the search results are gathered.

The data source 345a-n (collectively referred to as 345) includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data source 345 may send asset information from the search application 303, via the network interface 326, to the server 330.

The platform 330 may be housed with the text generation module 230 and its submodules described in FIG. 2. In some implementations, platform 330 may receive data from search application 303 and/or network interface 326 at the data source 345 via the network 360 to generate user-engageable elements incorporating search results. The generated user-engageable elements may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the search platform model 230. In one implementation, the database 332 may store user input queries, user profile information, search application information, search API information, or other information related to a search being performed or a search previously performed.

In some embodiments, database 332 may be local to the platform 330. However, in other embodiments, database 332 may be external to the platform 330 and accessible by the platform 330, including cloud storage systems and/or databases that are accessible over network 360.

The platform 330 includes at least one network interface component 333 adapted to communicate with user device 310 and/or data sources 345a and 345b-345n over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Workflows

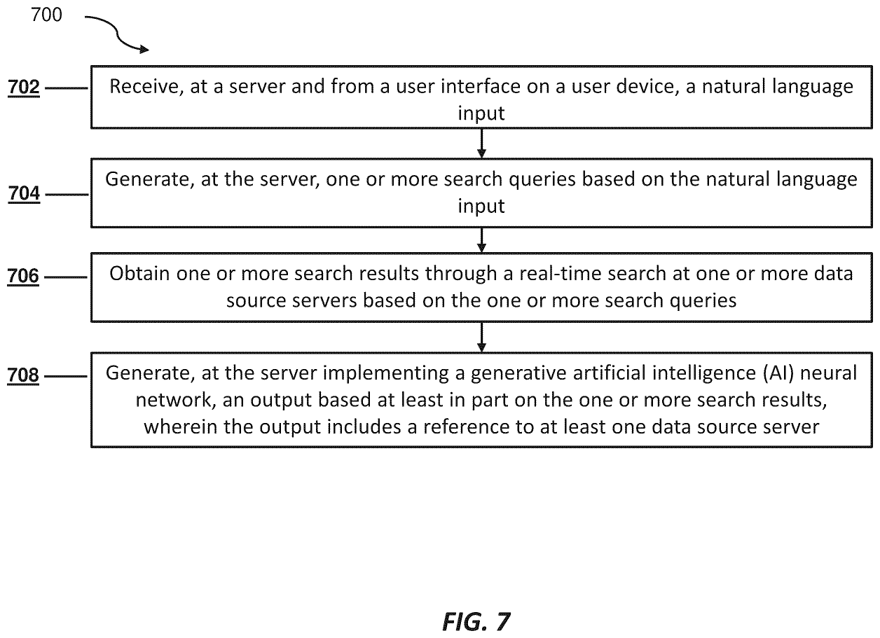

FIG. 7 is an example logic flow diagram illustrating a method of customized search based on the framework and architecture shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 800 corresponds to the operation of the code text generation module 230 (e.g., FIGS. 2-6) that performs searches based on user inputs and uses an NL model to provide natural language responses to conversational search queries.

At step 702, a natural language input is received at a server and from a user interface on a user device. As shown in FIG. 4, according to some embodiments, this input may include one or more of a natural language user input 402, user context 404, or other context 406. In some embodiments, the natural language user input 402 is a conversational or natural language query provided by the user. In some embodiments, the natural language input may be one or more of a text input, an audio input, an image input, and a video input

At step 704, the server generates one or more search queries based on the natural language input received at step 702. In some embodiments, this step may be performed by a parser network. The generation of the search queries may be performed, for example, as a preprocessing stage by NL preprocessing submodule 231 (discussed above in FIG. 2), or may be performed by a search submodule 232 (discussed above in FIG. 2) as part of a search operation.

In some embodiments, the server may further determine one or more potential search objects in the generated search queries. This may be used to determine particular data sources that would be beneficial to search based on the input, particular APIs to access, and/or the like. In some embodiments where the server is performing more than one search, this step may be used to determine that previous search results are relevant to the search objects for the current input. In this manner, resources may be saved by avoiding the need to perform multiple overlapping searches where previous search results may be sufficient to provide a natural language output to the most recent input.

At step 706, the server obtains one or more search results through a real-time search at one or more data source servers based on the one or more search queries. More information about how searches are performed are shown in co-pending and commonly-owned U.S. nonprovisional application Ser. No. 17/981,102, which is incorporated by reference. In some embodiments, the searches are performed at least in part based on search objects identified in step 704.

At step 708, the server generates a natural language output based at least in part on the one or more search results, and includes a reference to at least one data source server. In some embodiments, the output is generated entirely by the server receiving and processing inputs and performing searches. In other embodiments, the output is generated at least in part through the use of an external NL network or LLM interfaced through LLM interface submodule 234 (discussed in FIG. 2).

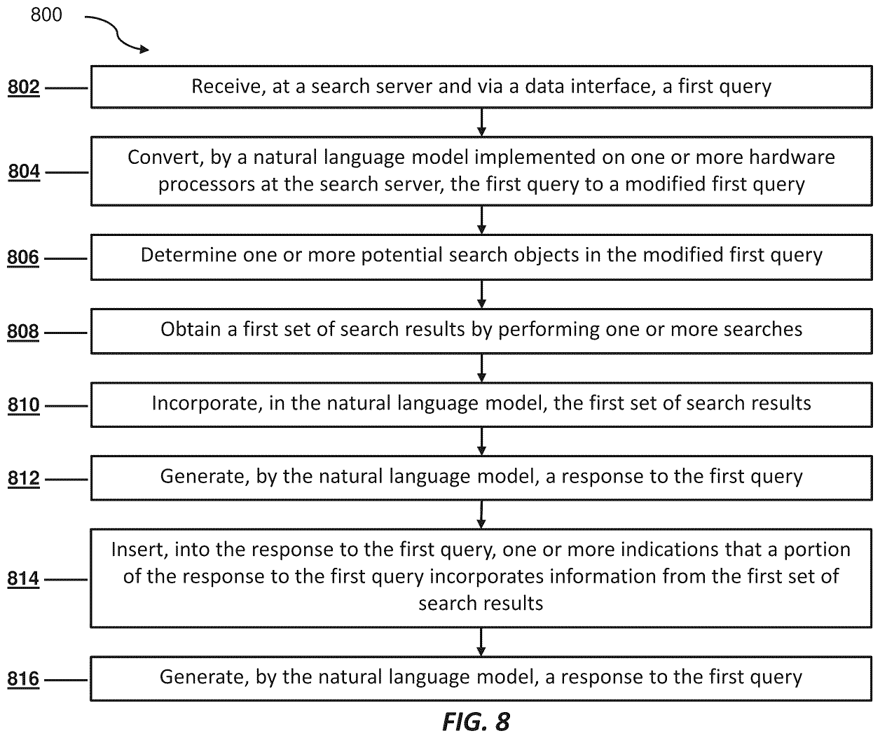

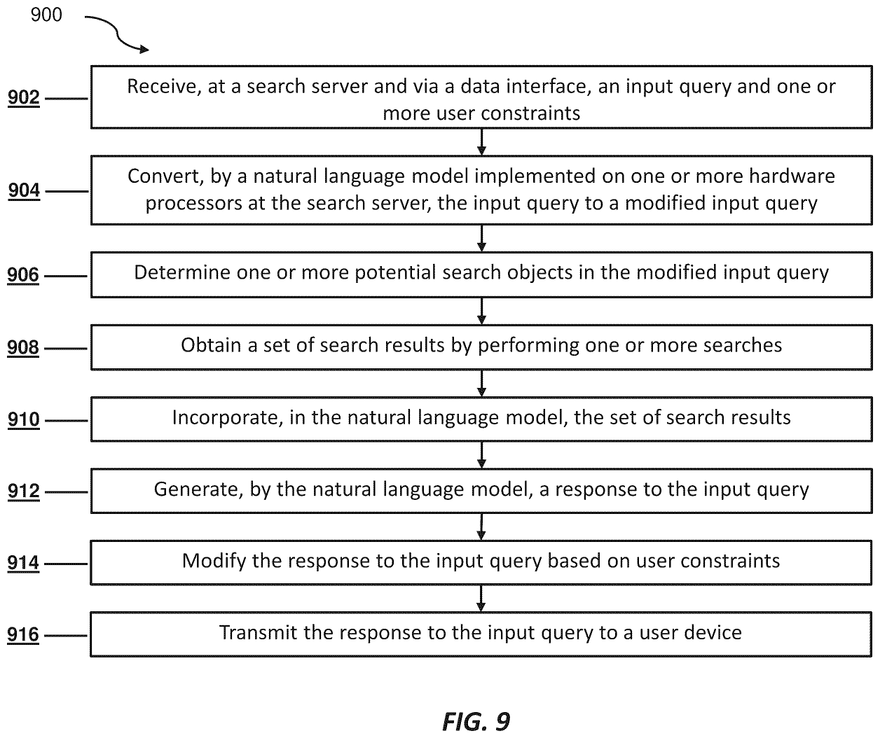

In this manner, the server is able to provide one or more natural language outputs that include indications of web pages, PDFs, images, videos, and other sources that were used to generate the natural language output, as discussed above with reference to FIGS. 1-6 and further discussed below with reference to FIGS. 8-9.

FIG. 8 is an example logic flow diagram illustrating a method of customized search based on the framework and architecture shown in FIGS. 1-6, according to some embodiments described herein. One or more of the processes of method 800 may be implemented, at least in part, in the form of executable code stored on non-transitory, tangible, machine-readable media that when run by one or more processors may cause the one or more processors to perform one or more of the processes. In some embodiments, method 800 corresponds to the operation of the code text generation module 230 (e.g., FIGS. 2-6) that performs searches based on user inputs and uses an NL model to provide natural language responses to conversational search queries.

At step 802, an input query is received by a search server via a data interface. As shown in FIG. 4, according to some embodiments, this input query may include one or more of a natural language user input 402, user context 404, or other context 406. In some embodiments, the natural language user input 402 is a conversational or natural language query provided by the user.

The generative AI system may also take into account user context when generating conversational responses to user queries. In some embodiments, user context 404 may include any combination of user profile information (e.g., user ID, user gender, user age, user location, zip code, device information, mobile application usage information, and/or the like), user configured preferences or dislikes of one or more data sources (e.g., as shown in co-pending and commonly-owned U.S. nonprovisional application Ser. No. 17/981,102), and user past activities approving or disapproving a search result from a specific data source. For instance, if a user previously disapproved of certain websites, then the generative AI system will prioritize other websites to collect information and provide a conversational response. Conversely, if a user previously approved of certain websites, the generative AI system may instead look to find results from the approved websites before searching other webpages to provide a conversational response.

In additional to context related to the user, the generative AI system may further consider other context, such as information related to prior user interactions with the generative AI system. In some embodiments, other context 406 may include one or more of previous user queries, previous responses by the generative AI system, previous searches performed by the generative AI system, and any other contextual information related to a current or previous interaction between the generative AI system and the user or the generative AI system and the internet.

At step 804, the search server may convert the input query into a modified query. In some embodiments, the search server may use an NL model implemented on one or more hardware processors at the search server to convert the input query. In this manner, the search server may convert the input query into an input sequence of tokens. In some embodiments, user context and other context, such as user preferences, may also be incorporated into the modified query and corresponding token sequence.

At step 806, the search server determines one or more potential search objects in the modified query. This may be key words or phrases within the modified query that are identified to be of particular interest.

At step 808, the search server performs a search based on an identified potential search object from the modified query. In some embodiments, when multiple potential search objects are identified in step 806, multiple searches may be performed such that a search is performed for each potential search object. In other embodiments, a single search may be performed based on more than one potential search object. Prior to performing the search, the search server may identify potential data sources that are relevant to the modified query. The search server may then transmit a search input based on potential search objects to the identified potential data sources, and incorporate the results into the set of search results. The relevant data sources may be identified based on one or more tokens generated from the user input, user context, and other context, may be based on previously identified relevant data sources, or may be directly provided by a user.

At step 810, the search results from the searches performed at step 808 are incorporated into the NL model and processed. For instance, the NL model may rank the search results, or the search results may have been ranked as they were received by the generative AI system.

At step 812, the NL model generates a response to the user query. The NL model utilizes the search results and corresponding information, the tokens incorporating the user query, user context, and other context, and other relevant information to generate a text-based response that corresponds to the desired output.

At step 814, the search server inserts citations into the response generated at step 812. The search server may insert one or more citations at the end of sentences to indicate where information contained in the sentences can be found in the search results, provide additional links to search results of interest, and otherwise provide context for the user.

At step 816, the search server transmits the response to the user query and the set of search results obtained because of the user query to the user device. In some embodiments, the result may further incorporate one or more search apps, one or more interactive graphical elements, or other data or application-based content relevant to the generated response.

In some embodiments, the search server will determine in steps 806-808 that one or more applications are relevant to the potential search objects in the user query. Accordingly, when obtaining a first set of search results in step 808 or after the response is generated by the NL model in step 812, the search server may identify APIs corresponding to one or more applications are relevant to the potential search objects identified in step 806. These applications may then be included as output with the response to the first query, such that information obtained through an API is provided to the user that is related to the first query.

The steps detailed above for method 800 may be repeated an indefinite number of times as the user responds to output provided by the search server, asks additional questions, or otherwise engages in a conversational back-and-forth. In this manner, the generative AI system is able to maintain a history of the conversation. This allows the generative AI system to maintain context as the user asks questions or otherwise interacts with the generative AI system, allowing for responses that are more accurately tailored to what the user is looking for. Additionally, this may allow the generative AI system to reduce resource usage by allowing searches performed for previous user inputs to be reused when it is determined that the current user input is sufficiently similar or otherwise can rely on the same set of search results that have already been gathered.

For instance, when a second (or third, or later) user input is provided, the generative AI system will convert the input query into a modified query as detailed in step 804. When the search server determines one or more potential search objects in the modified query as detailed in step 806, the search serve will determine whether any of the potential search objects in the user input are related to one or more potential search objects in an earlier input.

If the search server determines that the potential search objects are related to potential search objects from an earlier input, then the search server may use the search results related to the potential search objects from the earlier input rather than initiating a new search based on the search objects.

However, if the search server determines that the potential search objects are not related to potential search objects from an earlier input, than the search server may instead perform a new search based on the potential search objects of the current user input. This ensures that if a user asks an unrelated question to the search server or otherwise changes the context of user inputs, the search server is able to maintain responses that are relevant to the current user input. While the previous inputs may be utilized to determine additional relevant context for the current user input, performing a new search may nevertheless result in additional relevant information

FIG. 9 is an example logic flow diagram illustrating a method of a generative AI system based on the framework shown in FIGS. 1-6, according to some embodiments described herein. One or more of the processes of method 900 may be implemented, at least in part, in the form of executable code stored on non-transitory, tangible, machine-readable media that when run by one or more processors may cause the one or more processors to perform one or more of the processes. In some embodiments, method 900 corresponds to the operation of the text generation module 230 (e.g., FIGS. 2-6) that performs searches based on user inputs and uses an NL model to provide tailored written responses to user queries.

At step 902, an input query and one or more user constraints are received by a search server via a data interface. As shown in FIG. 4, according to some embodiments, the input query may include one or more of a natural language user input 402, user context 404, or other context 406. In some embodiments, the user query 402 is a conversational or natural language query provided by the user. The user constrains may include one or more parameters such as a use case, a desired tone, and a target audience.

At step 904, the search server may convert the input query and user constraints into a modified query. In some embodiments, the search server may use an NL model implemented on one or more hardware processors at the search server to convert the input query and user constraints. In this manner, the search server may convert the input query and user constraints into an input sequence of tokens. In some embodiments, user context and other context, such as user preferences, may also be incorporated into the modified query and corresponding token sequence.

At step 906, the search server determines one or more potential search objects in the modified query. This may be key words or phrases within the modified query that are identified to be of particular interest. The search server may also identify key user constraints to use in step 914 when modifying the output fulfil the provided user constraints.

At step 908, the search server performs a search based on an identified potential search object from the modified query. In some embodiments, when multiple potential search objects are identified in step 906, multiple searches may be performed such that a search is performed for each potential search object. In other embodiments, a single search may be performed based on more than one potential search object. Prior to performing the search, the search server may identify potential data sources that are relevant to the modified query. In some embodiments, particular data sources may be identified due to the provided user constraints determined in step 906. The search server may then transmit a search input based on potential search objects to the identified potential data sources, and incorporate the results into the set of search results. The relevant data sources may be identified based on one or more tokens generated from the user input, user context, and other context, may be based on previously identified relevant data sources, or may be directly provided by a user.

In step 910, the search results from the searches performed at step 908 are incorporated into the NL model and processed. For instance, the NL model may rank the search results, or the search results may have been ranked as they were received by the generative AI system.

At step 912, the NL model generates a response to the user query. The NL model utilizes the search results and corresponding information, the tokens incorporating the user query, user context, and other context, and other relevant information to generate a text-based response that corresponds to the desired output. While the response is modified based on user constraints in step 914, such as to ensure that the response meets a desired tone or audience, user constraints may further be taken into account when generating a response to the user query. For instance, the response may need to be shorter and more concise for a social media post use case, while for an essay use case, it may be desirable to generate a longer response.

In step 914, the search sever modifies the response based on user constraints. This may involve ensuring that the language used in the response meets a desired tone, or is at the desired reading level for a target audience.

In step 916, the search server transmits the response to the user query and the set of search results obtained because of the user query to the user device. In some embodiments, the result may further incorporate one or more search apps, one or more interactive graphical elements, or other data or application-based content relevant to the generated response.

FIGS. 10A-10E provide example UI diagrams illustrating an embodiment implementing a generative AI system incorporated into a search system. In an exemplary embodiment, the text generation tool may be implemented as a search assistance tool, such as an artificial intelligence (AI) chatbot that conduct a conversation with a user during a search and provide a summary of search results in response to user interested search topics. For example, when a user performs a search by entering a search term, the search engine may return a list of search results. The text generation tool may in turn generate a summary in response to the list of search results, and present the search summary to the user in the form of a conversational response. In other words, the input user query and the generated search results may be input to the generative

For instance, as shown in FIG. 10A, if a user searches for “best headphones,” the search engine may generate a list of search results relating to “best headphones.” In one implementation, data sources that are most relevant for the search query “best headphones,” e.g., shopping sites such as Looria, electronics rating site such as PCMag, etc. may be selected for conducting the search. Search results within each data source may be presented to the user within a respective horizontal panel. In one implementation, each data source may conduct its own independent search within its database in response to the search term. For example, the data source “PCMag” may search for “best headphones” based on reviewing articles of different headphones. Similarly, the data source “Looria” may search for “best headphones” based on user ratings, and/or the like.

In one embodiment, the search assistance tool may utilize the input search query and the returned search results to provide a conversational statement to the user summarizing what the best headphones. For example, as shown in FIG. 8A, the search tool may present in a conversational format, a summary describing “Sony WH-1000XM5” based on the search results from multiple data sources as relevant to the search term “best headphones,” as a search summary.

In some embodiments, the search assistance tool can further provide citations within the search summary to specific results from the search to allow quick access to the user to view results. For example, as shown in FIG. 10A, user-clickable citations to the “Sony WH-1000XM5” headphone is provided within the summary, such that a user may select to redirect to specific search results relating to “Sony WH-1000XM5.” The references also provide a layer of transparency to users to allow them to see how specific search results are impacting the output summary from the search assistance tool.

In this manner, the search assistance tool improves user search experience by providing a more comprehensible and readable search result output environment for the user and easy links to relevant webpages based on the results.

In some embodiments, the search assistance tool may implement a pre-trained language model and utilize the pre-trained model to provide conversational output to users based on the inputs. However, the search assistance tool further utilizes the search results as input for reference to allow the search assistance tool to be up-to-date and avoid outdated answers due to updates after training is completed. For example, if a new set of headphones are released after the training is completed, the search assistance tool can still provide output to the user that accounts for the updated headphones, and is thus relevant to the user despite changes in technology.

In a further embodiment, the search assistance tool may progressively update the search and the search summary as the user may provide additional conversational input, that allows the search assistance tool to provide a conversational result that is further refined. In response to a user conversational input, the search assistance tool may further determine whether the search engine shall refine previous search results, generate additional outputs based on previous search results and/or conduct a new search.

For example, as shown in FIG. 10B, following the example above, a user may further input “I only like over ear headphones—what are the best ones of those?” Based on this input, the search assistance tool may determine to refine a previous search based on “ear headphones,” and can accordingly provide input that is further tailored to the user's input and preferences, while maintaining a conversational element. In such instances, the search page may be slightly updated or remain unchanged while the conversation between the user and the AI chatbot takes place, to allow the user to continue to browse results while initiating a conversation.

In other embodiments, the search assistance tool may determine whether a refined search is needed. For instance, if the user's inputs begin asking about a specific brand of headphones, the initial search results may not have significant input on that brand of headphones. Accordingly, the AI chatbot can initiate refined search oriented towards that brand, to provide further input information to consider and output to the user with corresponding citations. This allows the AI chatbot to provide up-to-date information and output to the user that is contextually relevant, without requiring the user to initiate additional searches.

In another embodiment, the search assistance tool may determine to initiate a completely new search when the user input switches to a new topic. For example, following the search query on “best headphones,” if the user enters another input of “revert git commit,” as shown in FIG. 10C, the search assistance tool may determine that this would require a new search as it pertains to a completely different topic.

In this way, the generative AI system may not perform a new search each time an input is produced by the user, to save on computational resources and avoid overloading the search system, but instead may determine points where the context of the conversation has either changed to require new search results, or have gotten specific enough as to benefit from additional results from a more detailed search.

In further embodiments, the search assistance tool may provide a response corresponding to requested input. For instance, as shown in FIGS. 10C-10E, a user may search for “revert git commit” on specific help on writing code, and the search assistance tool may produce output which includes an explanation of how to write the code, with citations, as well as a code block that implements an example of the code to perform the task. The user may continue to ask follow-up questions (e.g., FIGS. 10D-10E), and the search assistance tool may refine its search results based on the user input, and generate an updated summary.

In a further implementation, a user may ask for a picture of an animal, such as a cat, and the search assistance tool may produce the image directly in the output alongside text. Accordingly, the search assistance tool can utilize the input information from both a user and search results to provide tailored output that is relevant and timely for the user.

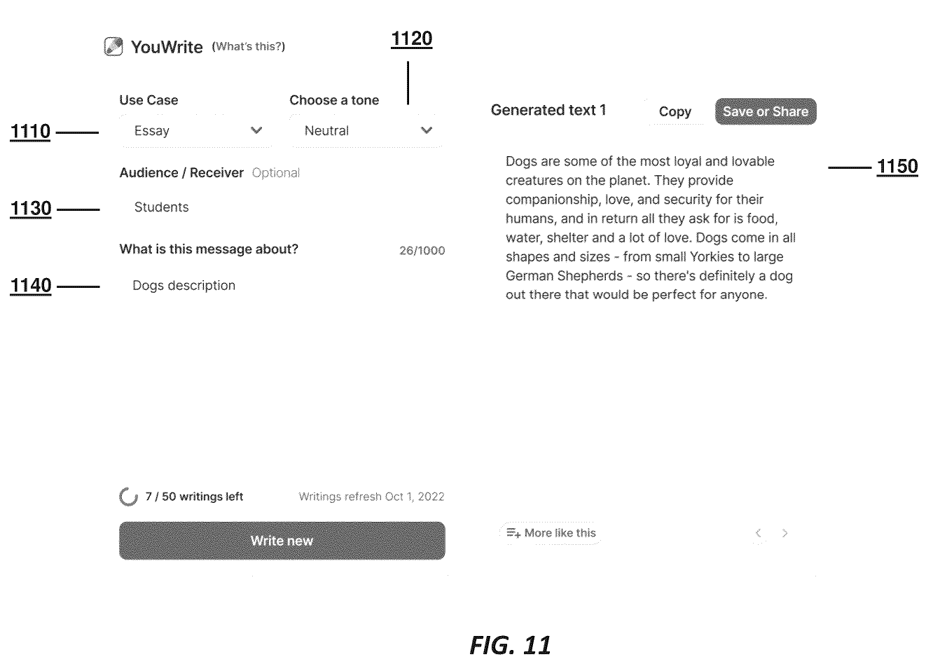

FIG. 11 provides an example UI diagram illustrating an embodiment implementing a text generation tool based on set user parameters. In some example embodiments, a text generation tool may be built upon the search engine to automatically generate a text based on user customization. For example, the text generation tool may include a generative model, that is provided via a web-based platform. The web-based platform interface allows a user to provide a customized user inputs relating to generating a text, such as the type of text, intended audience, tone, content, and/or the like.

A user may interact with the web-based platform interface to provide a query in the form of a desired topic 1140 for which a response should be generated. The generative AI system may take, as input, user constraints such as a use case 1110, a tone 1120, a target audience 1130. This information may be provided to the search server, such as described in step 902 of FIG. 9, where it is processed. Step 916 of FIG. 9 may then generate a response 1150 which is provided to the user via the web-based platform.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A processor-implemented method of neural network based text generation using real-time search results, the method comprising:
receiving, at a server and from a user interface on a user device, a natural language input;
generating, at the server, one or more search queries based on the natural language input;
obtaining one or more search results through a real-time search at one or more data source servers based on the one or more search queries; and
generating, at the server implementing a generative artificial intelligence (AI) neural network, an output based at least in part on the one or more search results, wherein the output includes a reference to at least one data source server.

2. The method of claim 1, wherein the natural language output is generated by the generative AI neural network at the server, and the generative AI neural network may comprise a language model.

3. The method of claim 1, further comprising:
transmitting a text generation input comprising the one or more search results to an external server hosting a language model; and
obtaining the output from the external server.

4. The method of claim 1, wherein the output is generated further based on user configured parameters including one or more of:
a type of the natural language output;
an intended audience of the natural language output;
a tone of the natural language output;
a format of the natural language output; and
a length of the natural language output.

5. The method of claim 1, wherein the obtaining one or more search results through a real-time search comprises obtaining content from a web file via a link in the one or more search results.

6. The method of claim 1, wherein the output includes a portion of text that is a summary of one or more search results, and the reference to at least one data source server indicates the portion of text relates to the at least one data source server.

7. The method of claim 1, wherein the natural language input comprises one or more of a text input, an audio input, an image input, and a video input.

8. A system for generating a neural network based text using real-time search results, the system comprising:
a communication interface that receives, via a user interface implemented on a user device, a natural language input;
a server implementing a generative artificial intelligence (AI) neural network and a plurality of processor-executable instructions; and
one or more processors executing the instructions to perform operations comprising:
generating, at the server, one or more search queries based on the natural language input;
obtaining one or more search results through a real-time search at one or more data source servers based on the one or more search queries; and
generating, at the server implementing a generative artificial intelligence (AI) neural network, an output based at least in part on the one or more search results, wherein the output includes a reference to at least one data source server.

9. The system of claim 8, wherein the natural language output is generated by the generative AI neural network at the server, and the generative AI neural network may comprise a language model.

10. The system of claim 8, further comprising:
transmitting a text generation input comprising the one or more search results to an external server hosting a language model; and
obtaining the output from the external server.

11. The system of claim 8, wherein the output is generated further based on user configured parameters including one or more of:
a type of the natural language output;
an intended audience of the natural language output;
a tone of the natural language output;
a format of the natural language output; and
a length of the natural language output.

12. The system of claim 8, wherein the obtaining one or more search results through a real-time search comprises obtaining content from a web file via a link in the one or more search results.

13. The system of claim 8, wherein the output includes a portion of text that is a summary of one or more search results, and the reference to at least one data source server indicates the portion of text relates to the at least one data source server.

14. The system of claim 8, wherein the natural language input comprises one or more of a text input, an audio input, an image input, and a video input.

15. A processor-readable non-transitory storage medium storing a plurality of processor-executable instructions for a neural network based text generation using real-time search results, the instructions being executed by one or more processors to perform operations comprising:
receiving, at a server and from a user interface on a user device, a natural language input;
generating, at the server, one or more search queries based on the natural language input;
obtaining one or more search results through a real-time search at one or more data source servers based on the one or more search queries; and
generating, at the server implementing a generative artificial intelligence (AI) neural network, an output based at least in part on the one or more search results, wherein the output includes a reference to at least one data source server.

16. The processor-readable non-transitory storage medium of claim 15, wherein the output is generated by the generative AI neural network at the server, and the generative AI neural network may comprise a language model.

17. The processor-readable non-transitory storage medium of claim 15, further comprising:
transmitting a text generation input comprising the one or more search results to an external server hosting a language model; and
obtaining the output from the external server.

18. The processor-readable non-transitory storage medium of claim 15, wherein the output is generated further based on user configured parameters including one or more of:
a type of the natural language output;
an intended audience of the natural language output;
a tone of the natural language output;
a format of the natural language output; and
a length of the natural language output.

19. The processor-readable non-transitory storage medium of claim 15, wherein the obtaining one or more search results through a real-time search comprises obtaining content from a web file via a link in the one or more search results.

20. The processor-readable non-transitory storage medium of claim 15, wherein the output includes a portion of text that is a summary of one or more search results, and the reference to at least one data source server indicates the portion of text relates to the at least one data source server.
